(19) United States
(12) Patent Application Publication
(10) Pub. No.: US 2001/0010162 A1
(43) Pub. Date: Aug. 2, 2001

(54) Method of making optical fiber

(75) Inventors: Kazuya Kuwahara, Yokohama-shi (JP); Ichiro Tsuchiya, Yokohama-shi (JP); Katsuya Nagayama, Yokohama-shi (JP); Masashi Onishi, Yokohama-shi (JP); Hiroshi Takamizawa, Yokohama-shi (JP)

Correspondence Address: MCDERMOTT WILL & EMERY, 600 13TH STREET, N.W., WASHINGTON, DC, 20005-3096, US

(73) Assignee: Sumitomo Electric Industries, Ltd.

(21) Appl. No.: 09/725,036

(22) Filed: Nov. 29, 2000

(30) Foreign Application Priority Data
Nov. 29, 1999 (JP) P1999-337835

(51) Int. Cl. C03B 37/07; C03B 37/075

(52) U.S. Cl. 65/381; 65/378; 65/382; 65/402

(57) ABSTRACT

When drawing an optical fiber from a preform, positive and negative dispersion sections of an optical fiber are provided, respectively, with target glass diameters different from each other, whereby the positive and negative dispersion sections attain their respective desirable values of chromatic dispersion. Also, the positive and negative dispersion sections and a transient section therebetween are provided, respectively, with values of control constant different from each other, which are used to converge the measured glass diameter to said target diameter, for adjusting the drawing speed, whereby the transient section is shortened. Alternatively, the positive and negative dispersion sections of the optical fiber are provided with respective target drawing speeds different from each other, whereby the transient section is shortened.

### BACKGROUND OF THE INVENTION

1. Field of the Invention

The present invention relates to a method of making an optical fiber provided with positive and negative dispersion sections having positive and negative chromatic dispersions at a predetermined wavelength, respectively, which sections are disposed alternately in the longitudinal direction of the optical fiber by drawing an optical fiber preform.

2. Related Background Art

It has been assumed that an optical fiber provided with positive and negative dispersion sections having positive and negative chromatic dispersions at a predetermined wavelength, respectively, which sections are disposed alternately in the longitudinal direction of the optical fiber for dispersion management, can suppress both of the waveform deterioration caused by nonlinear optical phenomena and that caused by cumulative chromatic dispersion, thereby being suitably usable as an optical transmission line of a wavelength division multiplexing (WDM) transmission systems (see, for example, JP 8-320419A).

In general, when making an optical fiber from an optical fiber preform, the lower end of the optical fiber preform is heated and melted in a drawing furnace, and this optical fiber preform is drawn, so as to produce the optical fiber. For making an optical fiber such as the one mentioned above, a special step is provided in order to change its chromatic dispersion in the longitudinal direction thereof.

For example, the above-mentioned JP 8-320419A discloses a technique in which an optical fiber preform whose core diameter or preform diameter changes in the longitudinal direction thereof is prepared, and the glass diameter is made constant when drawing an optical fiber from the preform, so as to longitudinally change the core diameter, thereby making an optical fiber whose chromatic dispersion changes in the longitudinal direction thereof. Also, it discloses a technique in which an optical fiber preform whose refractive index profile and preform diameter are longitudinally constant is prepared, and the glass diameter is changed when drawing an optical fiber from the preform, so as to change the core diameter, or the drawing tension is changed, so as to change the refractive index according to the residual stress, thereby making an optical fiber whose chromatic dispersion changes in the longitudinal direction thereof.

On the other hand, JP 11-30725A discloses a technique in which an optical fiber preform whose refractive index profile and preform diameter are constant in the longitudinal direction thereof is prepared, and the glass diameter is changed when drawing an optical fiber from the preform, so as to change the core diameter, thereby making an optical fiber whose chromatic dispersion changes in the longitudinal direction thereof.

### SUMMARY OF THE INVENTION

However, the above-mentioned conventional optical fiber making techniques have problems as follows. Namely, when an optical fiber is drawn at constant speed and constant tension from a preform whose core diameter and preform diameter longitudinally changes, the region where the diameter of preform changes becomes so long after drawing. When changing the fiber diameter upon drawing, a certain length of the optical fiber has to be drawn until a desirable value is attained. Thus, in any of the above-mentioned cases, a given length of the optical fiber where chromatic dispersion changes exists between positive and negative dispersion sections. This means that a given length of transient section on the chromatic dispersion between positive and negative dispersion sections exists in dispersion management optical fibers thus obtained. Since the absolute value of chromatic dispersion is small in this transient section, the effect of restraining the waveform from deteriorating due to nonlinear optical phenomena cannot fully be achieved.

In order to overcome the above-mentioned problems, it is an object of the present invention to provide a method of making an optical fiber which can easily make, with excellent controllability, an optical fiber whose chromatic dispersion at a predetermined wavelength changes in the longitudinal direction thereof.

The present invention provides a method of making an optical fiber provided with positive and negative dispersion sections having positive and negative chromatic dispersions at a predetermined wavelength, respectively, which are disposed alternately in the longitudinal direction of the optical fiber drawn from a preform; wherein, when drawing the optical fiber, the positive and negative dispersion sections of the optical fiber are provided, respectively, with target glass diameters different from each other, and the positive and negative dispersion sections and a transient section therebetween are provided, respectively, with values of control constant different from each other, which are used to converge the measured glass diameter to its target value, for adjusting a drawing speed.

According to this optical fiber making method, when drawing an optical fiber form a preform, the positive and negative dispersion sections of the optical fiber are provided, respectively, with target glass diameters different from each other, whereby the positive and negative dispersion sections can attain their respective desirable values of chromatic dispersion. Also, as the control constant based on glass diameter for adjusting the drawing speed is varied in the transient section between the positive and negative dispersion sections, so that deviations between the actual glass diameter and target glass diameters can be eliminated rapidly, whereby the transient section can be shortened. Namely, an optical fiber whose chromatic dispersion changes in the longitudinal direction thereof can be made with a favorable controllability according to this optical fiber making method. That is, the transient section, where chromatic dispersion changes, between the positive and negative dispersion sections can be shortened, whereby the optical fiber made thereby can fully attain the effect of restraining the waveform from deteriorating being due to nonlinear optical phenomena.

Also, the present invention provides a method of making an optical fiber; wherein, when drawing the optical fiber, the positive and negative dispersion sections of the optical fiber are provided with respective target glass diameters and target drawing speeds different from each other.

According to this optical fiber making method, the positive and negative dispersion sections of the optical fiber are provided, respectively, with target glass diameters different from each other, whereby the positive and negative dispersion sections can attain their respective desirable values of chromatic dispersion. Also, the positive and negative dispersion sections of the optical fiber are provided, respectively, with target drawing speeds different from each other, whereby the optical fiber can securely attain a desirable glass diameter in each section, and the transient section can be shortened. Namely, according to this optical fiber making method, an optical fiber whose chromatic dispersion changes in the longitudinal direction thereof can be made with a favorable controllability, and the transient section, where chromatic dispersion changes, between the positive and negative dispersion sections can be shortened, whereby the optical fiber made thereby can fully attain the effect of restraining the waveform from deteriorating being due to nonlinear optical phenomena.

Preferably, in this optical fiber making method, letting D₁ and V₁ be the target glass diameter and target drawing speed in the positive dispersion section, respectively, and D₂ and V₂ be the target glass diameter and target drawing speed in the negative dispersion section, respectively, the respective target glass diameters and target drawing speeds of the positive and negative dispersion sections of the optical fiber are set so as to satisfy the relational expression of D₁²×V₁=D₂²×V₂. In this case, only the target values are changed. The actual drawing speed differs from its target value by an amount of correction caused by control, nevertheless, it is preferred that this amount of correction is not returned to zero upon changing the target values. It is theoretically desirable to multiply the amount of correction by a coefficient, but practically, it is not necessary to multiply by coefficient within the range of the target values.

### BRIEF DESCRIPTION OF THE DRAWINGS

FIG. 1 is a view explaining an example of diameter changes in the optical fiber made by the method of making an optical fiber in accordance with the present invention;

FIG. 2 is a view explaining an example of refractive index profile of the optical fiber made by the method of making an optical fiber in accordance with the present invention;

FIG. 3 is a graph showing chromatic dispersion characteristics of optical fibers having the refractive index profile shown in FIG. 2;

FIG. 4 is a schematic explanatory view of a manufacturing apparatus for carrying out the method of making an optical fiber in accordance with the present invention;

FIG. 5 is a block diagram explaining the drawing speed control for the optical fiber in the method of making an optical fiber in accordance with the present invention;

FIG. 6 is a block diagram explaining the feeder speed control for the optical fiber preform in the method of making an optical fiber in accordance with the present invention;

FIG. 7 is a graph showing changes in drawing speed with time in examples and a comparative example as compared with each other; and

FIG. 8 is a graph showing longitudinal glass diameter distributions of optical fibers made in the examples and comparative example as compared with each other.

### DESCRIPTION OF THE PREFERRED EMBODIMENTS

In the following, embodiments of the present invention will be explained in detail with reference to the accompanying drawings. To facilitate the comprehension of the explanation, the same reference numerals denote the same parts, where possible, throughout the drawings, and a repeated explanation will be omitted.

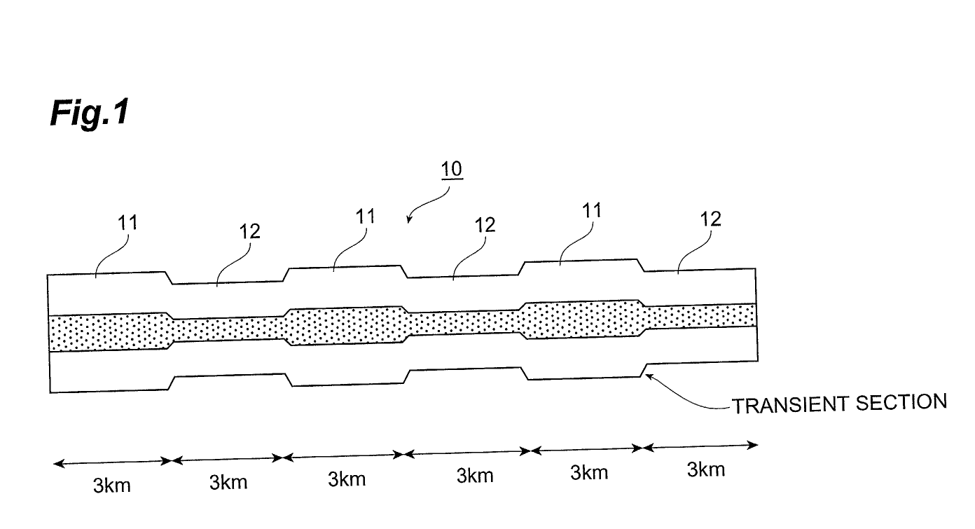

First, an example of optical fiber made by the method of making an optical fiber in accordance with the present invention will be explained with reference to FIG. 1. In the optical fiber 10 shown in this drawing, positive dispersion sections 11 having a positive chromatic dispersion at a predetermined wavelength (e.g., a wavelength of 1.55 μm) and negative dispersion sections 12 having a negative chromatic dispersion at the predetermined wavelength are disposed alternately in the longitudinal direction of the optical fiber 10, whereby dispersion management is effected. By holding the absolute value of local chromatic dispersion high (e.g., so as to become at least 1 ps/nm/km) in most of regions, the optical fiber 10 can restrain the waveform from deteriorating being due to nonlinear optical phenomena. Also, by lowering the average chromatic dispersion over the whole length, the optical fiber 10 can restrain the waveform from deteriorating being due to cumulative chromatic dispersion. Therefore, the optical fiber 10 is suitably used as an optical transmission line of a WDM transmission system. In the optical fiber 10, the positive dispersion section 11 and negative dispersion section 12 are provided with glass diameters and core diameters different from each other. There are transient section, where the diameter changes, between the positive dispersion section 11 and the negative dispersion section 12

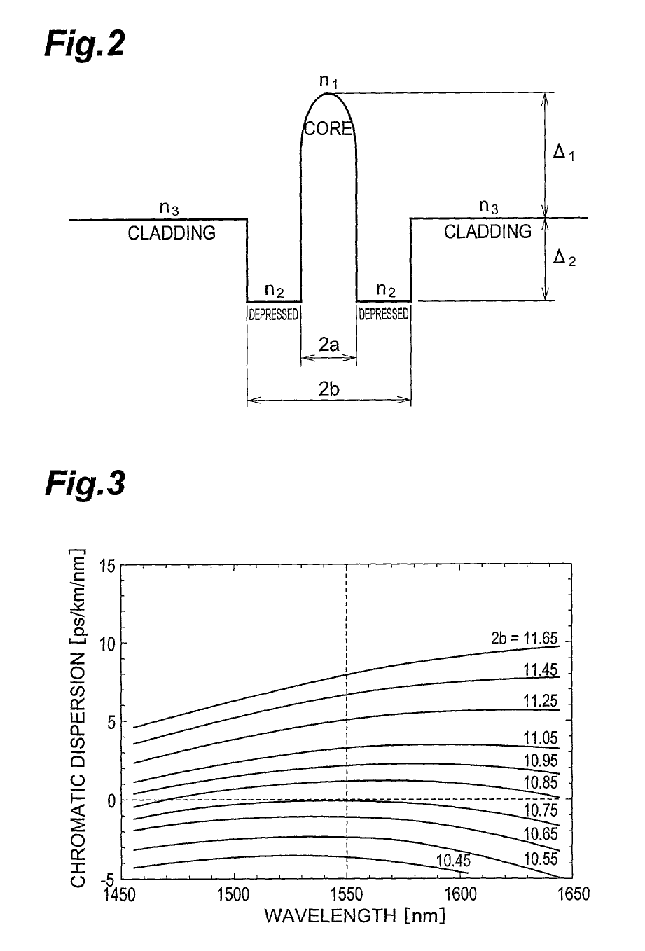

FIG. 2 is an explanatory view of an example of refractive index profile of the optical fiber 10. FIG. 3 is a graph showing chromatic dispersion characteristics of optical fibers having the refractive index profile shown in FIG. 2. The optical fiber 10 comprises, successively from its center, a core region having a maximum refractive index n₁ and an outside diameter 2a, a depressed region having a refractive index n₂ and an outside diameter 2b, and a cladding region having a refractive index n₃, whereas the individual refractive indices have a relationship of n₁>n₃>n₂ in terms of magnitude. Such a refractive index profile can be realized, for example, when the core region and the depressed region consist of GeO₂-doped SiO₂ and F-doped SiO₂ respectively, while the cladding region consists of SiO₂.

The graph shown in FIG. 3 indicates the wavelength dependence of chromatic dispersion with respect to each value (10.45 μm to 11.65 μm) of outside diameter 2b of the depressed region. Here, with reference to the refractive index of cladding region, the relative refractive index difference of core region Δ₁=n₁−n₃ is set to 0.9%, the relative refractive index difference of depressed region Δ₂=n₂−n₃ is set to −0.45%, and the ratio (2a/2b) of the respective outside diameters of core region and depressed region is set to 0.58. As shown in this graph, the chromatic dispersion at a wavelength of 1.55 μm becomes greater as the outside diameter 2b of depressed region increases, i.e., the outside diameter 2a of core region increases.

In the optical fiber 10 explained in FIGS. 1 to 3, each positive dispersion section 11 has a glass diameter of 131 μm and a chromatic dispersion of +3 ps/nm/km. Each negative dispersion section 12 has a glass diameter of 123 μm and a chromatic dispersion of −3 ps/nm/km.

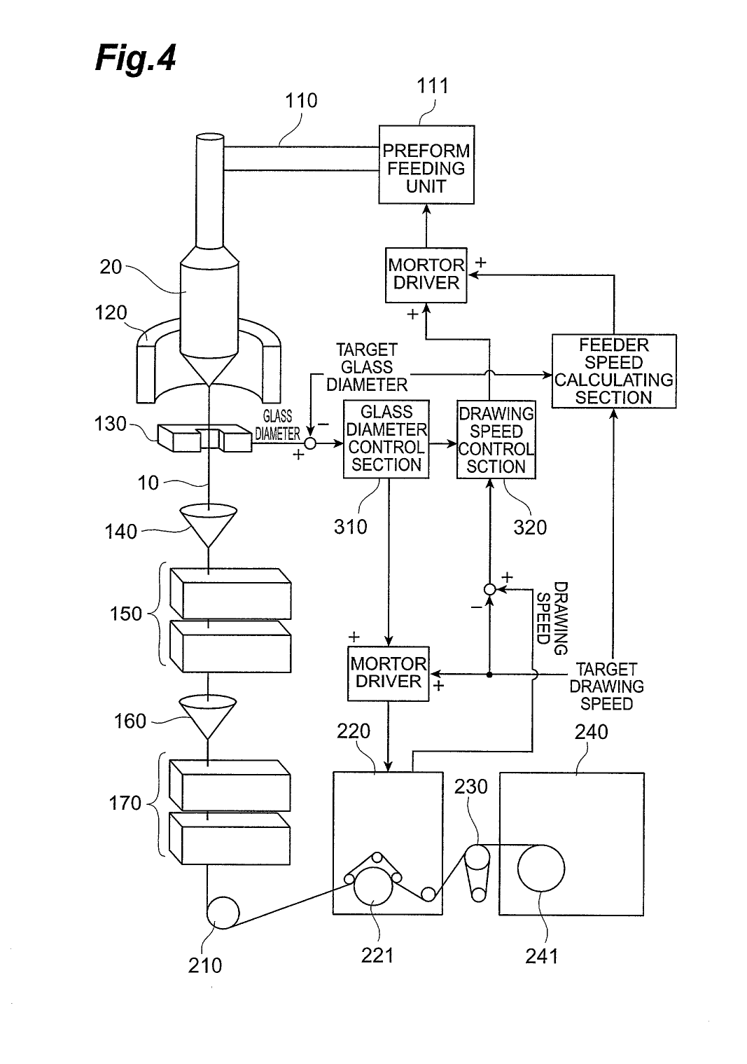

An outline of the method of making an optical fiber will now be explained with reference to FIG. 4. Characteristic features of the method of making an optical fiber in accordance with the present invention will be explained later. This drawing schematically shows an optical fiber manufacturing apparatus, in which control sections are depicted as a block diagram.

In this optical fiber manufacturing apparatus, an optical fiber preform 20 is attached to a feeder 110 and is set within a drawing furnace 120. Then, the lower end of the optical fiber preform 20 is heated and melted by the heater of the drawing furnace 120, so as to form a neck-down part, and the optical fiber 10 is drawn from thus heated and melted lower end of optical fiber preform 20. The optical fiber 10 coming out of the drawing furnace 120 is, with its glass diameter being measured by a glass diameter meter 130, forcibly cooled by cooling unit (not depicted). The result of measurement effected by the glass diameter meter 130 is reported to a glass diameter control section 310.

Thereafter, the optical fiber 10 passes through a resin coating die 140, so as to be coated with a resin, which subsequently is cured by ultraviolet light irradiation with a UV lamp 150, whereby the optical fiber 10 is covered with a primary coating. Further, the optical fiber 10 passes through a resin coating die 160, so as to be coated with a resin, which subsequently is cured by ultraviolet light irradiation with a UV lamp 170, whereby the optical fiber 10 is covered with a secondary coating. The optical fiber 10 thus covered with the resin coatings is taken up by a bobbin 241 of a take-up 240 by way of a roller 210, a capstan 221 of a fiber puller 220, and a dancer section 230 in succession.

Based on a set drawing speed, the glass diameter control section 310 controls the drawing speed of the optical fiber 10 in the fiber puller 220 such that the glass diameter of optical fiber 10 measured by the glass diameter meter 130 converges to its target values. Based on a feeder speed calculated from the target drawing speed, preform diameter, and target glass diameter, a drawing speed control section 320 controls the feeder speed of the preform feeding unit 111. In response to a command from the drawing speed control section 320 and a feeder speed calculating section, the preform feeding unit 111 drives the feeder 110, so as to insert the optical fiber preform 20 into the drawing furnace 120. In response to a command from the glass diameter control section 310 and the set drawing speed, the fiber puller 220 drives the capstan 221, so as to set the drawing speed of optical fiber 10.

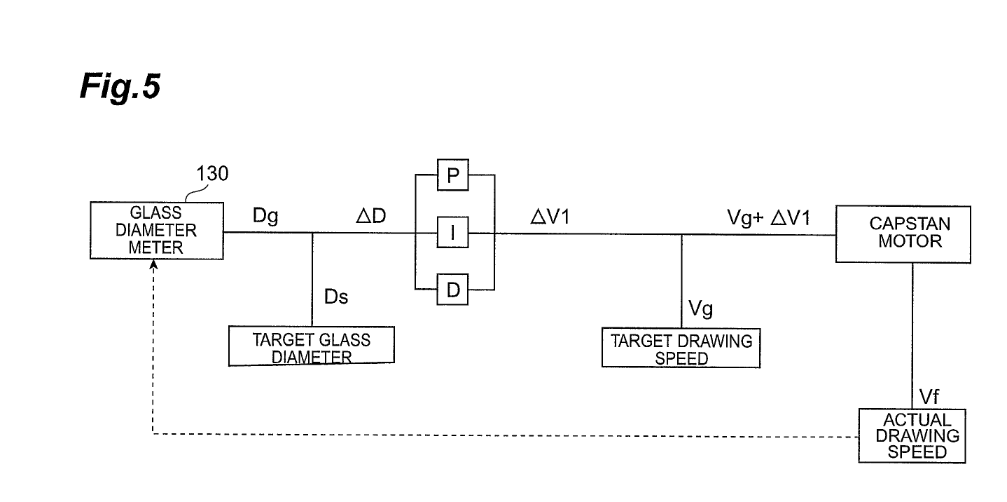

The glass diameter control and drawing speed control effected by the glass diameter control section 310 and drawing speed control section 320 will now be explained. FIG. 5 is a block diagram explaining the drawing speed control for the optical fiber 10. From the actually measured glass diameter value D_{g} measured by the glass diameter meter 130 and the target glass diameter Dₛ, a glass diameter deviation ΔD is determined by the following expression:

ΔD=D_{g}−Dₛ (1)

According to this glass diameter deviation ΔD, a drawing speed control amount ΔV₁ is determined by the following expression:

ΔV₁=α₁×ΔD+β₁×∫ΔDdt+γ₁×ΔD/dt (2)

From the drawing speed control amount ΔV₁ and a target drawing speed V_{g}, the drawing speed vf of optical fiber 10 is determined by the following expression:

V_{f}=V_{g}(1+ΔV₁) (3)

Then, based on the drawing speed V_{f}, the rotational speed of capstan 221 of the fiber puller 220 is controlled.

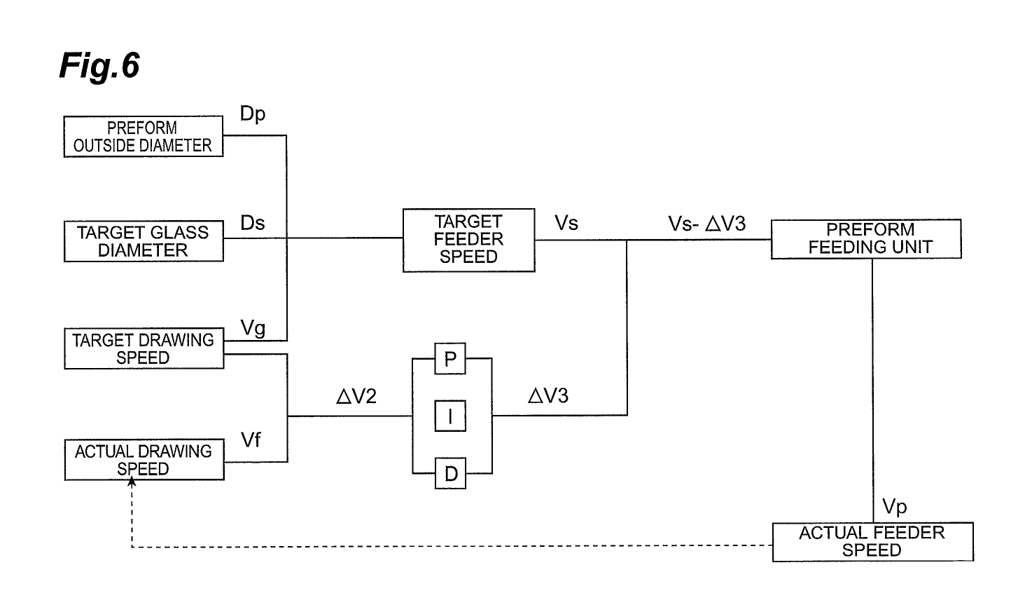

FIG. 6 is a block diagram explaining the feeder speed control for the optical fiber preform 20. According to the preform outside diameter Dₚ of optical fiber preform 20, the target glass diameter Dₛ of optical fiber 10, and the target drawing speed V_{g} of optical fiber 10, the target feeder speed Vₛ of optical fiber preform 20 is determined by the following expression:

Vₛ=(Dₛ/Dₚ)²×V_{g} (4)

On the other hand, according to the target drawing speed V_{g} and actual drawing speed V_{f} of optical fiber 10, a drawing speed deviation ΔV₂ is determined by the following expression:

ΔV₂=V_{f}−V_{g} (5)

According to this drawing speed deviation ΔV₂, the feeder speed control amount ΔV₃ of optical fiber preform 20 is determined by the following expression:

ΔV₃=(Dₛ/Dₚ)²×└α₂×ΔV₂+β₂×∫ΔV₂dt+γ₂×ΔV₂/dt┘ (6)

According to the set feeder speed Vₛ and feeder speed control amount ΔV₃ of optical fiber preform 20, the feeder speed Vₚ of optical fiber preform 20 is determined by the following expression:

Vₚ=Vₛ−ΔV₃ (7)

Then, according to the feeder speed Vₚ, the feeding speed of optical fiber preform 20 generated by the preform feeding unit 111 is controlled.

In practice, both the capstan motor and preform feeder motor employ servo motors, whereas respective motor drivers carry out appropriate control therewithin in order to stably realize drawing speeds V_{g}+ΔV₁, Vₛ−ΔV₃ to be inputted. It will be sufficient if recommended values for motor meters are used. For example, values of the control constants appearing in the above-mentioned expressions (2) and (6) are:

α₁=5×10² [/m] (8a)

β₁=5×10⁴ [/m·s] (8b)

γ₁=0 [s/m] (8c)

α₂=0.75 [−] (8d)

β₂=0.005 [/s] (8e)

γ₂=0 [s] (8f)

The drawing speed control for the optical fiber and the feeder speed control for the optical fiber preform are coupled with each other at the drawing speed V_{f} of optical fiber 10, thus failing to form independent control systems. However, while the glass diameter control responds in seconds, the drawing speed control responds in minutes since it accompanies changes in the melting state of optical fiber preform 20. As a consequence, the time constant greatly differs between the respective control systems for glass diameter control and drawing speed control, whereby the two control systems can be treated as substantially independent systems.

The characteristic features of a first embodiment of the method of making an optical fiber in accordance with the present invention, which will be explained in detail in the following, reside in that, in the optical fiber making method explained in the foregoing, the positive dispersion section 11 and negative dispersion section 12 of the optical fiber 10 are provided, respectively, with target glass diameters different from each other, and the positive dispersion section 11, negative dispersion section 12, and transient section are provided with their respective different values of control constant based on glass diameter for the drawing speed in expression (2). A second embodiment is characterized in that the positive dispersion section 11 and negative dispersion section 12 of the optical fiber 10 are provided with target glass diameters different from each other and target drawing speeds different from each other. As a consequence, the transient section between the positive dispersion section 11 and negative dispersion section 12 becomes shorter in the dispersion management optical fiber 10, whereby the effect of restraining the waveform from deteriorating due to nonlinear optical phenomena can fully be achieved.

First Embodiment

To begin with, the first embodiment of the method of making an optical fiber in accordance with the present invention will be explained. In the first embodiment, the positive dispersion section 11 and negative dispersion section 12 of the optical fiber 10 are provided, respectively, with target glass diameters Dₛ different from each other, whereas the positive dispersion section 11 and negative dispersion section 12, and transient section are provided with their respective different values of control constant based on glass diameter for the drawing speed.

In the following explanation, it is assumed that the positive dispersion section 11 is drawn at a constant glass diameter during a period from time t₁ to time t₂, the target glass diameter is changed at time t₂, the actually measured glass diameter value converges to the target glass diameter at time t₃, and the negative dispersion section 12 is drawn at a constant glass diameter during a period from time t₃ to time t₄.

During the period (from time t₁ to time t₂) when the positive dispersion section 11 is drawn while the target glass diameter Dₛ is set at a constant diameter D₁, the drawing speed control amount ΔV₁ is determined by the above-mentioned expression (2). Also, the drawing speed control amount ΔV₁ is determined by the above-mentioned expression (2) during the period (from time t₃ to time t₄) when the negative dispersion section 12 is drawn while the target glass diameter Dₛ is set at a constant diameter D₂. During the period (from time t₂ to time t₃) drawing the transient section where the actually measured glass diameter value D_{g} changes between the positive dispersion section 11 and negative dispersion section 12, however, the drawing speed control amount ΔV₁ is determined by the following expression:

ΔV₁=2×α₁×ΔD+2×β₁×∫ΔDdt+γ₁×ΔD/dt (9)

Thus, the control constants (2α₁, 2×β₁) for the drawing speed in the transient section are two times the respective control constants (α₁, β₁) in the positive dispersion section 11 and negative dispersion section 12, and are different from each other. As for β₁, however, only its part during the period from time t₂ to time t₃ is changed. This is possible without any problems in current digital processing control systems.

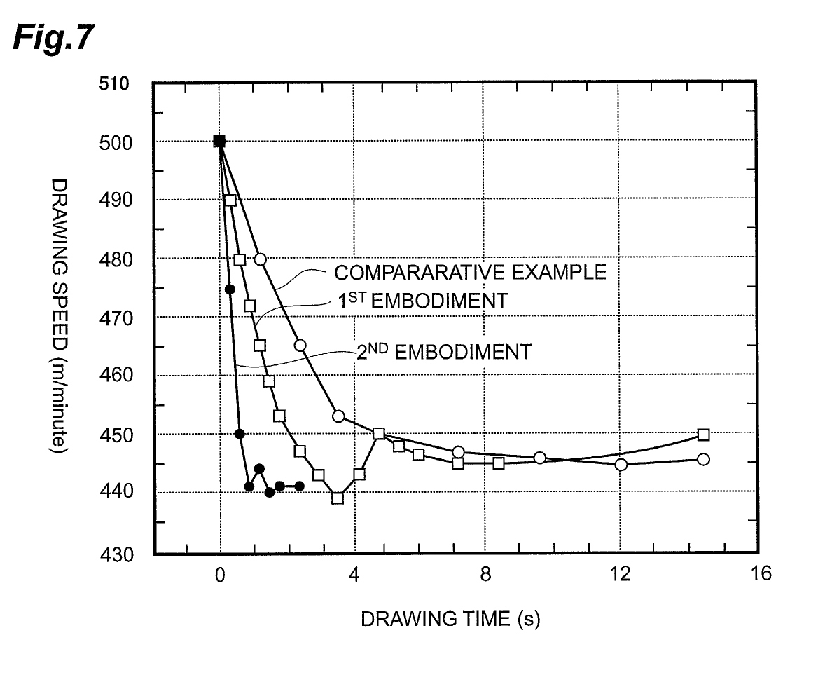

In this case, if the target glass diameter was changed while the target drawing speed V_{g} was kept at a constant value of 500 m/min, and the drawing speed control constant of transient section was twice that of each of the positive dispersion section 11 and negative dispersion section 12, then it took 60 m as the length of optical fiber 10 until the actually measured glass diameter value converged to the target glass diameter from the time when the target glass diameter was altered. In this embodiment, since the volume flow rate of glass drawn from the preform would change between before and after the target glass diameter was altered, it took a relatively long period of time until the glass diameter and drawing speed became stable after the setting was altered. Also, since the preform feeder speed changed due to actions of the drawing speed control system, the drawing speed of optical fiber gradually approached the target drawing speed of V_{g}=500 m/min after once dropped greatly as shown in FIG. 7.

When control was carried out according to the above-mentioned expression (9) immediately after starting the drawing, oscillation was likely occur upon the glass diameter and drawing speed at the time of initial low drawing speed, whereby the drawing speed was hard to increase. Therefore, it is desirable that the drawing speed control constants be changed when actually altering the glass diameter after a stable drawing speed for production is attained.

Second Embodiment

The second embodiment of the method of making an optical fiber in accordance with the present invention will now be explained. In the second embodiment, the positive dispersion section 11 and negative dispersion section 12 of the optical fiber 10 are provided with respective target glass diameters Dₛ varied each other and respective target drawing speeds V_{g} varied each other.

More preferably, let D₁ and V₁ be the target glass diameter Dₛ and target drawing speed V_{g} in the positive dispersion section 11, respectively, and D₂ and V₂ be the target glass diameter Dₛ and target drawing speed V_{g} in the negative dispersion section 12, respectively. Then, the respective target glass diameters and target drawing speeds of the positive dispersion section 11 and negative dispersion section 12 of optical fiber 10 are set so as to satisfy the following relational expression:

D₁²×V₁=D₂²×V₂ (10)

Here, such an operation as ΔV₁ and ΔV₃ are set to be zero is not carried out. Also, none of α₁, β₁, γ₁, α₂, β₂, and γ₂ is altered. As V_{g} is altered, the amount of control V_{g}ΔV₁ slightly changes, but its effect is small. This is theoretically superior in terms of continuity.

For example, let the target glass diameter D₁ and target drawing speed V₁ in the positive dispersion section 11 be 131 μm and 440.8 m/min, respectively, and the target glass diameter D₂ and target drawing speed V₂ in the negative dispersion section 12 be 123 μm and 500 m/min, respectively. In this case, it took 12 m as the length of optical fiber 10 until the actually measured glass diameter value converged to the target glass diameter from the time when the target glass diameter was altered.

Comparative Example

The optical fiber making method of a comparative example will now be explained. In this comparative example, only the target glass diameter Dₛ is varied at the positions between the positive dispersion section 11 and negative dispersion section 12 of the optical fiber 10. Namely, the drawing speed control constant and the target drawing speed V_{g} are kept at a constant.

In this case, if the target glass diameter was changed while the target drawing speed V_{g} was kept at a constant value of 500 m/min, then it took 100 m as the length of optical fiber 10 until the actually measured glass diameter value converged to its target value from the time when the target glass diameter was altered. In this comparative example, since the volume flow rate of glass drawn from the preform changed if the target glass diameter was changed, the drawing speed of optical fiber 10 fluctuated during a relatively long period of time. Due to actions of the drawing speed control system, however, the drawing speed of optical fiber 10 gradually approached the target drawing speed of V_{g}=500 m/min.

Comparison of First and Second Embodiments and Comparative Example The respective optical fiber making methods of the first and second embodiments and comparative example will now be compared with each other.

FIG. 7 is a graph showing the change of drawing speed with time. This graph is based on the time when the target glass diameter is altered. As can be seen from this graph, the drawing speed of optical fiber 10 in the comparative example started changing from the time when the target glass diameter was altered, and attained its minimum value about 12 seconds thereafter. Then, the drawing speed started to approach its original value of 500 m/min, and further approached 500 m/min though not depicted. In the first embodiment, the drawing speed of optical fiber 10 started changing from the time when the target glass diameter was altered, and attained its minimum value about 4 seconds thereafter. Then, the drawing speed started to approach its original value of 500 m/min, and further approached 500 m/min though not depicted. In the second embodiment, the drawing speed became stable at a new setting value 440.8 m/min after 2 seconds from the time when the target glass diameter was changed.

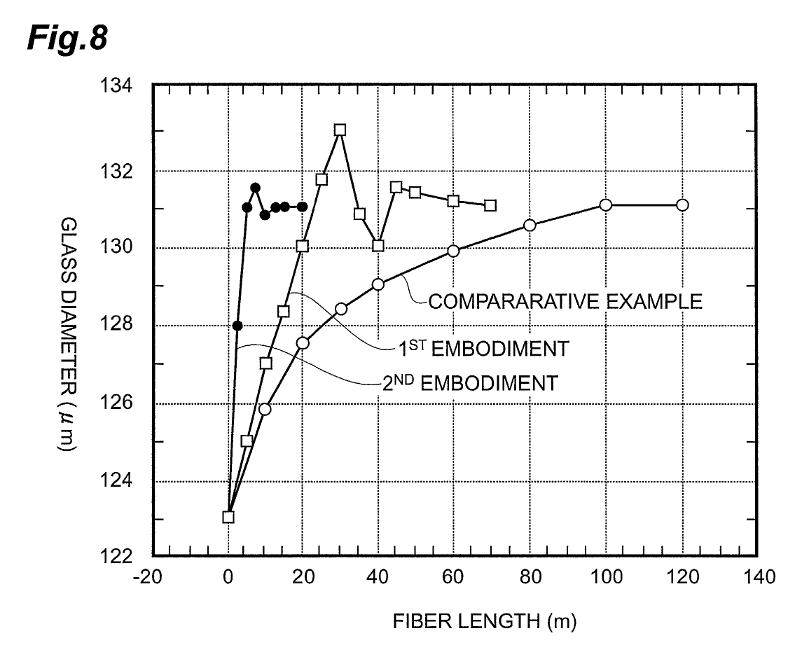

FIG. 8 is a graph showing the longitudinal glass diameter distribution of optical fiber 10. This graph is also based on the time when the target glass diameter is changed. As can be seen from this graph, the length of optical fiber 10 needed for the actually measured glass diameter value to converge to its target value is 100 m, 60 m, and 12 m in the comparative example, first embodiment, and second embodiment, respectively.

As in the foregoing, the time required for the drawing speed to become stable and the fiber length required for the actually measured glass diameter value to converge to its target value are shorter in the first and second embodiments than in the comparative example. Also, the time required for the drawing speed to become stable and the fiber length required for the actually measured glass diameter value to converge to its target value are shorter and the actually measured glass diameter value converges more stably in the second embodiment than in the first embodiment.

Therefore, according to the respective optical fiber making methods in accordance with the first and second embodiments, the optical fiber 10 whose chromatic dispersion changes in the longitudinal direction thereof can be made with a favorable controllability, and the transient section where chromatic dispersion changes between the positive and negative dispersion sections can be shortened. Hence, the optical fiber 10 made thereby can fully achieve the effect of restraining the waveform from deteriorating due to nonlinear optical phenomena. Such an effect is more remarkable in the second embodiment than in the first embodiment.

What is claimed is:

1. A method of making an optical fiber provided with positive and negative dispersion sections having positive and negative chromatic dispersions at a predetermined wavelength, respectively, which sections are disposed alternately in a longitudinal direction of the optical fiber drawn from a preform;
wherein, when drawing the optical fiber, said positive and negative dispersion sections of said optical fiber are provided, respectively, with target glass diameters different from each other, and said positive and negative dispersion sections and a transient section therebetween are provided, respectively, with values of control constant different from each other, which are used to converge the measured glass diameter to said target diameter, for adjusting a drawing speed.

2. A method of making an optical fiber provided with positive and negative dispersion sections having positive and negative chromatic dispersions at a predetermined wavelength, respectively, which sections are disposed alternately in a longitudinal direction of the optical fiber drawn from a preform;
wherein, when drawing the optical fiber, said positive and negative dispersion sections of said optical fiber are provided with respective target glass diameters and target drawing speeds different from each other.

3. A method of making an optical fiber according to claim 2, wherein, letting D₁ and V₁ be the target glass diameter and target drawing speed in said positive dispersion section, respectively, and D₂ and V₂ be the target glass diameter and target drawing speed in said negative dispersion section, respectively, the respective target glass diameters and target drawing speeds of said positive and negative dispersion sections of said optical fiber are set so as to satisfy the relational expression of D₁²×V₁=D₂²×V₂.
